(19) United States
(12) Patent Application Publication
(10) Pub. No.: US 2011/0278168 A1
(43) Pub. Date: Nov. 17, 2011

(54) COMPOSITE MATERIAL FOR USE IN A SENSING ELECTRODE FOR MEASURING WATER QUALITY

(75) Inventor: Serge Zhuiykov, Highett (AU)

(73) Assignee: COMMONWEALTH SCIENTIFIC AND INDUSTRIAL RESEARCH ORGANISATION, Campbell (AU)

(21) Appl. No.: 12/991,833

(22) PCT Filed: May 8, 2009
(86) PCT No.: PCT/AU09/00581

§ 371 Date: Nov. 19, 2010

(30) Foreign Application Priority Data
May 9, 2008 (AU) 2008902285

(51) Int. Cl. G01N 27/30; B05D 5/00; C09K 3/00; B05D 3/02; B82Y 30/00

(52) U.S. Cl. 204/407; 252/408.1; 204/400; 204/433; 427/380; 427/201; 977/777; 977/776

(57) ABSTRACT

A composite material for use in a sensing electrode. The composite material comprises a first phase and a second phase. The first phase consists essentially of Bi₂Ru₂O₇₊ₓ wherein x is a value between 0 and 1 and the second phase consists essentially of RuO₂.

### CROSS-REFERENCE TO RELATED APPLICATIONS

The present application claims priority from Australian Provisional Patent Application No 2008902285 filed on 9 May 2008, the content of which is incorporated herein by reference.

### FIELD OF THE INVENTION

The present invention relates to a composite material for use in a sensing electrode. The present invention further relates a method of preparing a composite material and an in-situ device for evaluating the quality of a body of water.

### BACKGROUND

Water quality analysers and instrumentation have been an integral part of industrial and wastewater treatment applications. However with the growing awareness of environmental issues, the monitoring of additional parameters and the improvement in the sensitivity measurements of such parameters, beyond the capability of traditional water quality analysers, are now sought.

In-situ analysers and instrumentation for measuring parameters indicative of water quality are desirable for several reasons. Real time and continuous measurements provide an opportunity to capture small scale variations which traditional sampling methods may otherwise miss and are statistically more representative of any particular measurement parameter.

Martinez-Mánez¹ recently developed a multi-parametric analyser for measuring the quality of water. The analyser was composed of a planar ceramic substrate. On a first side of the substrate was positioned a reference electrode and sensing electrodes for measurement of conductivity, pH, oxidation-reduction potential and dissolved oxygen. On a reverse side of the substrate was positioned a temperature sensor and a turbidity sensor. To prepare the sensing electrodes, three screens were used corresponding to the conductive layer working as a conductor of the signal, the active layer, which is different for each of the different electrodes, and a protective later.

Resistive pastes containing 24 mol % of ruthenium were used as the active paste for each of the sensing electrodes. The ruthenium oxidises to RuO₂ during the firing process at 700° C. in a cycle of 30 minutes with a 10 minute peak. RuO₂ has shown sensing properties towards measurement of the sensing electrodes parameters, namely conductivity, pH and dissolved oxygen. However, RuO₂ does not readily adhere to the surface of substrates used in electrodes. There is a need to provide materials for use in a sensing electrodes which have a higher proportion of RuO₂ than the materials known in the prior art and which adhere to the surface of electrode substrates.

### SUMMARY OF THE INVENTION

In a first aspect, the present invention provides a composite material for use in a sensing electrode said composite material comprising a first phase and a second phase wherein said first phase consists essentially of Bi₂Ru₂O₇₊ₓ, where x is a value between 0 and 1, and wherein said second phase consists essentially of RuO₂.

During the preparation of the composite material, the second RuO₂ phase localises on the surface of the composite material due to the decreased density of the second phase relative to the density of the first Bi₂Ru₂O₇₊ₓ phase.

In a preferred form, the RuO₂ phase comprises nanoparticles of RuO₂ on the surface of the composite material.

In a preferred form, the composite material comprises a minor proportion of silica (SiO₂). Preferably, the proportion of silica is no less than 10 mol. %.

More preferably, the molar ratio of ruthenium (Ru) to silicon (Si) in the composite material is greater than 6:1. Yet more preferably, the ratio is 68 to 10.

In a second aspect, the present invention provides a sensing electrode comprising a composite material according to the first aspect applied to a substrate.

In a third aspect, the present invention provides a method of preparing a composite material according to the first aspect comprising the steps of:

(a) mixing RuO₂, Bi₂O₃ and SiO₂ in the molar ratio 68:22:10 (RuO₂:Bi₂O₃:SiO₂) to form a mixture;

(b) heating said mixture in air from ambient temperature to about 400° C. at a rate of 65° C. per hour and retaining the mixture at about 400° C. for two hours;

(c) subsequently heating said mixture to about 965° C. at a rate of 100° C. per hour whereby the first and second phases are formed.

Although silica may be present in the composite material, it cannot be detected by XRD measurements and its precise location in the material cannot readily be ascertained. In any case, the silica does not appear to be relevant to the sensing capacity of the composite material

Preferably, the mixture of step (a) is applied to a substrate before the mixture is heated in step (b).

Preferably, the RuO₂, Bi₂O₃ and SiO₂ are in the form of powders, preferably nanopowders. Preferably the nanopowders have average particle size of between 10 nm and 500 nm.

More preferably, the RuO₂ nanopowder is heated in air at 900° C. for 2 hours prior to step (a).

This step of pretreating the RuO₂ in air is to stabilise the RuO₂ structure and to obtain the tetragonal phase of crystal structure which is required for sensor applications.

Preferably, the substrate is alumina.

Preferably, the substrate is alumina coated with a thin Pt film. The Pt film may have a thickness of between 3 μm and 15 μm and more preferably between 5 μm and

In a fourth aspect, the present invention provides an in-situ device for evaluating the quality of a body of water, the in-situ device comprising:

a planar substrate which is immersible in a body of water;

a plurality of sensing electrodes supported on a surface of the planar substrate, each sensing electrode responsive to a different parameter to measure the quality of the body of water; and

a signal processing unit to process signals received from each of the sensing electrodes to provide a measure of the quality of the body of water, where each sensing electrode is electrically connected to the signal processing means via a conductor supported on the surface of the substrate;

where at least one sensing electrode comprises a composite material defined in accordance with the first aspect of the invention, or any one of its embodiments.

Preferably, the plurality of sensing electrodes include a pair of conductivity sensing electrodes for measuring conductivity, a pH sensing electrode for measuring pH and a dissolved oxygen sensing electrode for measuring dissolved oxygen. Preferably, a reference electrode is additionally supported on a surface of the planar substrate for the respective measurements of pH and dissolved oxygen.

Each sensing electrode and the reference electrode may be supported on a first surface of the planar substrate.

The in-situ device may further comprise a temperature sensor supported on either the first or the second surface of the planar substrate.

A portion of the planar substrate may comprise an aperture for the passage of water there-through.

The in-situ device may further comprise a turbidity sensor including a light emitter and a first photodetector, where the light emitter is supported on a surface of the planar substrate and configured to emit light across the aperture, and where the photodetector is supported on a surface of the planar substrate and configured to receive emitted light and produce a signal indicative of the received light.

The light emitter is preferably an infrared light emitter.

The photodetector may be one of a photodiode, for instance a silicon photodiode, a silicon photomultiplier device, a charged coupled device array and a CMOS array.

The surface of the planar substrate on which the light emitter and the photodetector are supported may be the same surface.

The turbidity sensor may include a second photodetector. The configuration of the first and second photodetectors relative to the light emitter may be such that the first photodetector provides a measure of the absorption of light by non-dissolved particles in the water and the second photodetector provides a measure of the dispersion of light by non-dissolved particles in the water.

The signal processing unit may be in communication with a potential difference measuring device which is operable to measure a potential difference between the pH sensing electrode and the reference electrode and between the dissolved oxygen sensing electrode and the reference electrode.

The signal processing unit may be in communication with memory which stores an algorithm for calculating the pH from values of the potential difference and from a values representative of the temperature which are delivered respectively by the pH sensing electrode, the reference electrode and the temperature sensor.

The signal processing unit may be in communication with a conductivity meter which is operable to measure a potential between the pair of conductivity sensing electrodes.

Each conductor may comprise metals and silicon containing materials, such as doped or undoped polysilicon and amorphous silicon. Metals may include single metals as well as metal alloys containing two or more metals. Specific examples of metals include aluminum, copper, nickel, palladium, platinum, silver, tantalum, titanium, tungsten, zinc, aluminum-copper alloys, aluminum alloys, copper alloys, titanium alloys, tungsten alloys, titanium-tungsten alloys, gold alloys, nickel alloys, palladium alloys, platinum alloys, silver alloys, tantalum alloys, zinc alloys, metal silicides, and any other alloys thereof.

In a fifth aspect, the present invention provides an in-situ device for evaluating the quality of a body of water, the in-situ device comprising:

a planar substrate which is immersible in a body of water, the planar substrate comprising an aperture for the passage of water there-through;

a turbidity sensor including a light emitter and a first photodetector, where the light emitter is supported on a surface of the planar substrate and configured to emit light across the aperture, and where the photodetector is supported on a surface of the planar substrate and configured to receive emitted light and produce a signal indicative of the received light;

a plurality of sensing electrodes supported on a surface of the planar substrate, each sensing electrode responsive to a different parameter to measure the quality of the body of water; and

a signal processing unit to process signals received from the turbidity sensor and each of the plurality of sensing electrodes to provide a measure of the quality of the body of water, where the turbidity sensor and each sensing electrode is electrically connected to the signal processing means via a conductor supported on the substrate.

The light emitter is preferably an infrared light emitter.

The photodetector may be one of a photodiode, for instance a silicon photodiode, a silicon photomultiplier device, a charged coupled device array and a CMOS array.

The surface of the planar substrate on which the light emitter and the photodetector are supported may be the same surface.

The turbidity sensor may include a second photodetector. The configuration of the first and second photodetectors relative to the light emitter may be such that the first photodetector provides a measure of the absorption of light by non-dissolved particles in the water and the second photodetector provides a measure of the dispersion of light by non-dissolved particles in the water.

Preferably, at least one sensing electrode comprises a composite material defined in accordance with the first aspect, or any one of its embodiments.

The plurality of sensing electrodes preferably includes a pair of conductivity sensing electrodes for measuring conductivity, a pH sensing electrode for measuring pH and a dissolved oxygen sensing electrode for measuring dissolved oxygen. Preferably, a reference electrode is additionally supported on a surface of the planar substrate for the respective measurements of pH and dissolved oxygen.

Each sensing electrode and the reference electrode may be supported on a first surface of the planar substrate.

The in-situ device may further comprise a temperature sensor supported on either the first or the second surface of the planar substrate.

The signal processing unit may be in communication with a potential difference measuring device and/or a conductivity meter as described in relation to the fourth aspect of the invention.

### BRIEF DESCRIPTION OF THE FIGURES

Preferred embodiments of the present invention will now be described, by way of example only, and with reference to the accompanying drawings in which:—

FIG. 1 is a view of one surface of a water monitoring sensor in accordance with an embodiment of the invention;

FIG. 2 is a view of another surface of the water monitoring sensor shown in FIG. 1;

FIG. 3 is a cross sectional view of a sensing electrode comprising a composite material in accordance with the invention;

FIG. 4 is a SEM micrograph of the sensing electrode shown in FIG. 3;

FIG. 5 is a graph showing EMF variation vs pH measured in water for a sensing electrode comprising a composite material in accordance with the invention; and

FIG. 6 is a graph showing EMF variations vs dissolved oxygen measured in water for a sensing electrode comprising a composite material in accordance with the invention.

### DETAILED DESCRIPTION OF THE INVENTION

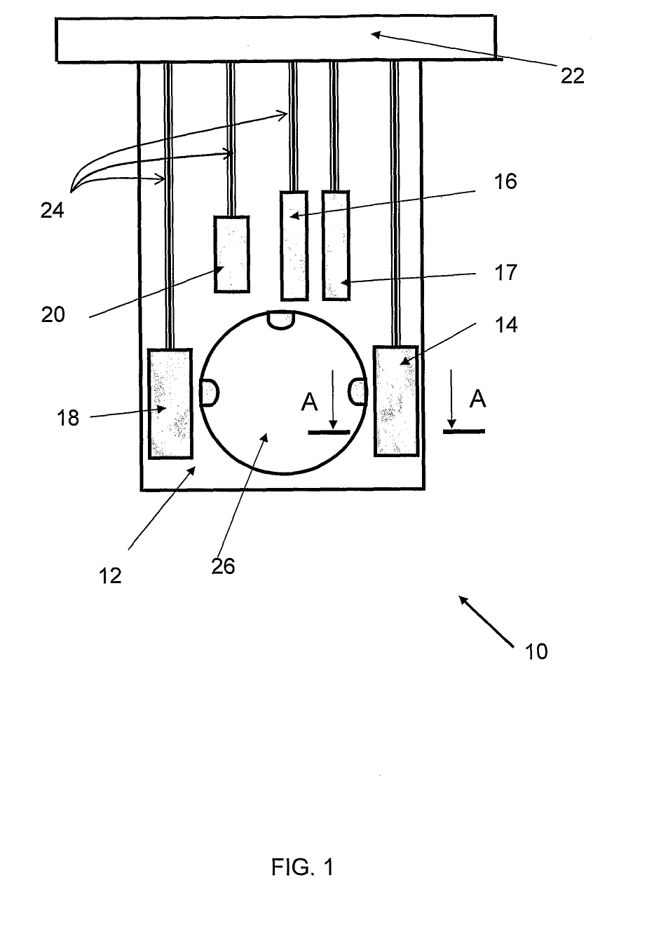

FIG. 1 illustrates a view of a first surface of an in-situ device 10 for evaluating the quality of a body of water. Central to the in-situ device 10 is a planar substrate 12 which comprises an aperture 26 for the passage of water, when the in-situ device 10 is immersed in water. The planar substrate 12 is composed of alumina and has dimensions of approximately 35 mm×60 mm×1.5 mm.

Supported on a first surface of the planar substrate 12 is a pH sensor which comprises a sensing electrode 14 and a reference electrode 20, a conductivity sensor comprising sensing electrodes 16 and 17, and a dissolved oxygen sensor comprising sensing electrode 18 and the reference electrode 20. Signals from each of the sensor electrodes 12, 14, 16, 17, 18 and the reference electrode 20 are fed to a signal processing circuit (not shown) contained in the housing 22 via electrical current conductors 24.

Current conductors 24 are supported on the substrate and form conductive paths between the respective electrodes and the signal processing circuit. The current conductors 24 contain a material that conducts electrical current. In this embodiment, the current conductor 24 comprises platinum.

Sensing electrodes 14, 16, 17 and 18 are each composed of a composite material comprising a first phase which consists essentially of Bi₂Ru₂O₇₊ₓ where 0<x<1 and a second phase which consists essentially of RuO₂. The RuO₂ phase comprises nanoparticles of RuO₂ on the surface of the composite material. The composite material comprises a minor proportion of silica and the molar ratio of the molar ratio of ruthenium (Ru) to silicon (Si).in the composite material is 68:10. The Bi₂Ru₂O₇₊ₓ phase acts as a flux for RuO₂ adhesion to the alumina substrate 12. The composite material is prepared by first pre-treating raw RuO₂ nano-powder in air at 900° C. for approximately two hours. This stabilizes the crystal structure. The pre-treated RuO₂ is then combined with Bi₂O₃ and SiO₂ in the molar ratio 68:22:10 (RuO₂:Bi₂O₃:SiO₂) to form a mixture. The mixture is applied to the first surface of the alumina substrate 12 at locations 14, 16, 17 and 18. The mixture is then heated in air, from an ambient temperature to 400° C., at a rate of 65° C. per hour and the mixture is retained at 400° C. for two hours. The mixture is subsequently heated to 965° C. at a rate of 100° C. per hour whereby the first and second phases are formed. Sensing electrodes 14, 16, 17 and 18 are thus formed.

The sensors formed from the reference electrode 20 and the sensing electrodes 14, 16, 17 and 18 will now be considered in turn. The reference electrode 20 comprises a silver electrode which provides a solderable interface region to which electrical connection can be made. Overlaying the silver electrode, an insulation layer is provided and at the end thereof remote the connection interface, a silver halide region is formed comprising AgCl. Overlaying the silver halide region, a halide salt region, comprising for example potassium chloride, is provided in the form a printable medium, comprising a polymer paste. The pH-active surface of the sensing electrode 14, making up the pH sensor, has an approximate area of 6 mm² and a thickness of approximately 10 μm to 30 μm.

The signal processing circuit is in communication with a meter to provide the potential difference between the pH sensing electrode 14 and the reference electrode 20 and for reading and recording changes therein due to changes measured at the surface sensing electrode 14.

Electrolytic conductivity X is defined as the conductance G between the two sensing electrodes 16 and 17 which are separated by a distance d. Conductivity can be expressed as: X=Gk. For invariant measurement conditions, k is constant and then the conductivity is directly proportional to the conductance. For the conductivity measurement, an alternating square wave voltage is used that produces a fall of voltage between the two sensing electrodes 16 and 17 that is proportional to the conductivity of the fluid.

Referring to the dissolved oxygen sensor, adsorption of oxygen dissolved in water at the interface of the sensing electrode 18 and the aqueous solution can be explained by the following redox reaction:

O_{2,aq}+e⁻ [symbol] O_{2,ads}⁻ and O_{2,aq}+2e⁻ [symbol] O_{2,ads}²⁻

Although this gross reaction is generally accepted to explain the reaction mechanisms of dissolved oxygen on the surface of a transitional metal oxide sensing electrode below 40° C., the elementary reaction steps are still a matter of discussion. These oxygen species belong to the surface lattice and their frequencies differ from those M—O bonds in the bulk, because the surface O₂⁻ is bound to a lower number of metal atoms on the surface. This will result in an electrical potential difference being produced between the sensing electrode 18 and the reference electrode 20. Measurement of a potential difference will indicate that the dissolved oxygen is present in the aqueous solution. If, however, the aqueous solution is free from dissolved oxygen, there will be no adsorption on the sensing electrode 18.

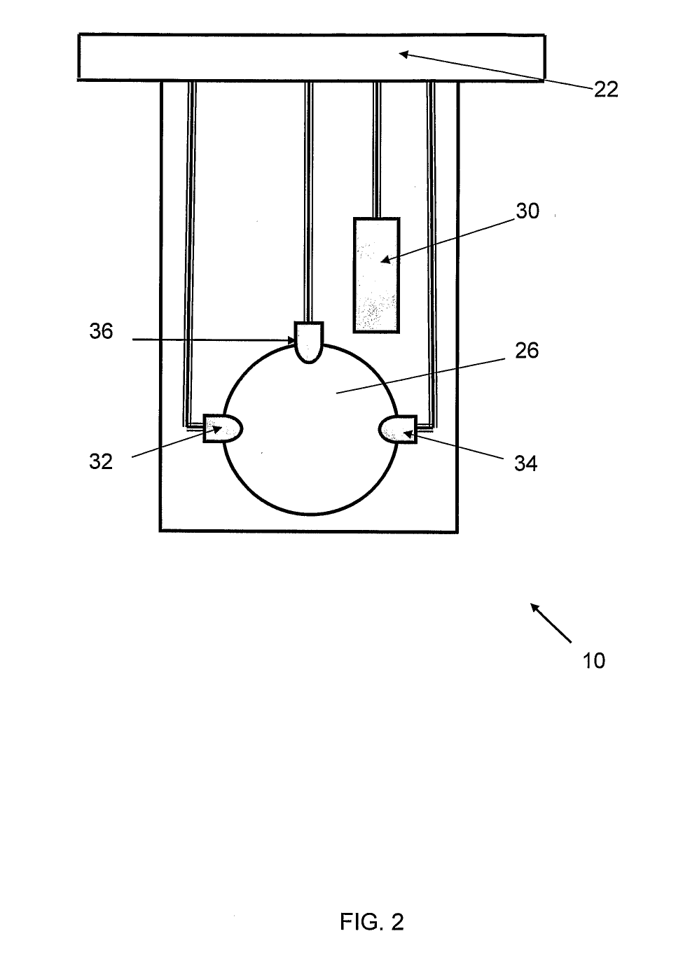

FIG. 2 illustrates a view of a second surface of the in-situ device 10. Supported on the second surface of the alumina substrate 12 is a temperature sensor 30 and a turbidity sensor (32, 34, 36).

The temperature sensor 30 comprises an electrothermal material such as a thermistor and is capable of measuring temperature from 5° C. to 100° C. The temperature sensor 30 may be a positive temperature coefficient material such as ruthenium oxide or platinum, or a negative temperature coefficient material such as nickel oxide. The material may be deposited onto the alumina substrate 12 by a screen printing process, permitting the use of patterning technology such as screen printing stenciling, photolithography, sputtering etc.; whereby the shape of the sensor will conform to a specified area.

Turbidity refers to the reduction of the transparency of a liquid due to the presence of non-dissolved materials. The turbidity sensor comprises a transmitting element 32 in the form of an infrared diode and a pair of photodetectors 34, 36 each in the form of a photodiode. One of the photodiodes 34 is located opposite the transmitting element 32 and gathers the direct transmission of the radiation measuring the absorption and the other photodiode 36 is located at a direction of 90 degrees with respect to the transmitting element 32 and gathers radiation dispersed by non-dissolved particles. The output from each photodiode 34, 36 that measures a signal indicative of the light intensity is coupled to a current converter, or light intensity to frequency converter (not shown), to generate a signal whose frequency corresponds to and varies with the turbidity level of the fluid. Each current converter includes an operational amplifier of very low current of polarization.

The configuration of the transmitting element 32 relative to each of the photodiodes 34, 36 enhances the sensitivity of the measure of turbidity irrespective of the device's 10 orientation with respect to a flow of water. The aperture 26 is made in the body of substrate 12 at a distance of about five to ten mm from an end of the substrate 12. The diameter of the aperture 26 is approximately 26 mm ensuring the optimum sensitivity of the turbidity sensor.

The signal processing circuit contained in the housing 22 includes a printed circuit board of surface mount technology, containing the relevant circuits for the signal processing of the signals received from the reference electrode 20, each of the sensor electrodes 14, 16, 17 and 18 and the temperature sensor 30 and the photodiodes 34, 36. A total of 12 analog inputs are used for the signals provided by each component.

In another embodiment, the sensing electrodes 14, 16, 17 and 18 may be deposited onto thin platinum (Pt) films located on the same surface of alumina substrate 12. Such an embodiment may provide improved adhesion. In order to deposit the sensing electrodes 14, 16, 17 and 18, the Pt thin-films are required to be annealed on the alumina substrate 12 at a temperature of about 1000° C. for about one hour to ensure suitable adhesion to the surface of the alumina substrate 12. Respective sensing electrodes are then deposited onto the respective Pt thin films such that they completely cover the thin film. This ensures that the Pt thin film is not exposed to the aqueous solution when the device 10 is immersed in water.

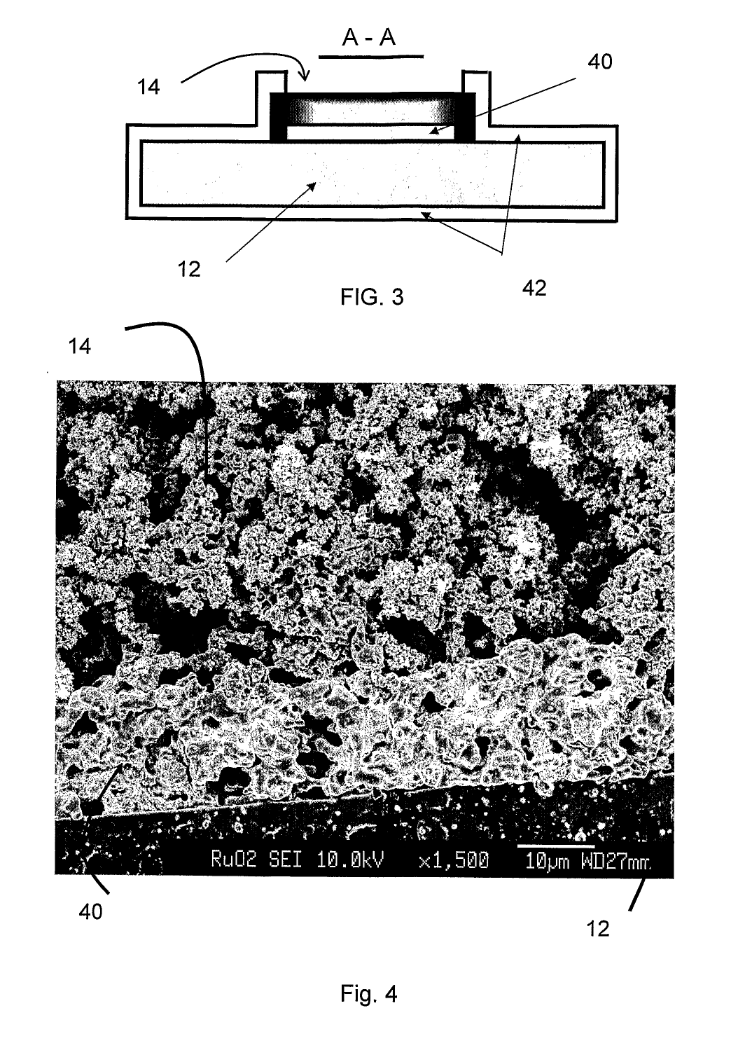

FIG. 3 illustrates a sectional view of a portion of an in-situ device whereby illustrates a sensing electrode has been deposited on a Pt film. As illustrated, a conductive layer made up of a Pt thin film 40, and having a thickness of a ˜10 μm, is deposited onto the relevant section of a surface of the alumina substrate 12. The sensing electrode, in this case pH sensing electrode 14 is deposited onto the layer of Pt thin film 40. An isolating layer (protective layer) 42 covers all areas of substrate 12, except the active area of the sensing electrode 14. The isolating layer 40 is composed of an overglaze paste fired at temperature of 600° C. in a 30 minute cycle with a peak of 5 minutes to form the final thickness after firing of about 30 μm.

It should be appreciated that in an in-situ device fabricated in this manner, the isolating layer 42 covers all surfaces of alumina substrate 12, except the active areas of each of the temperature sensor 30, the turbidity sensor (32, 34, 36) the sensing electrodes 14, 16 and 18 and the reference electrode 20.

FIG. 4 illustrates a SEM micrograph of the deposition of the sensing electrode 14 onto a Pt film 40 shown in FIG. 3. The Pt film 40, which has been fired onto the alumina substrate 12, has a thickness of approximately 10 μm to 30 μm.

### Tests and Results

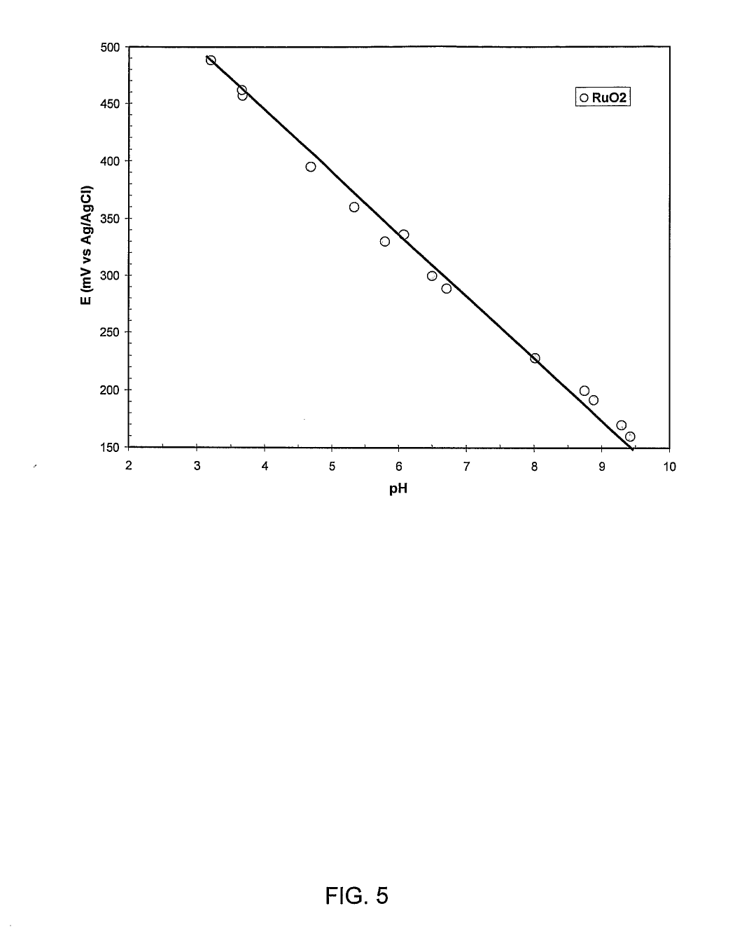

A series of tests were conducted to show the working of the in-situ device 10. In the first test, the performance of the pH sensor of the in-situ device 10 was tested potentiometrically in the temperature range of 9 to 23° C. The pH sensing performance of the Bi₂Ru₂O₇₊ₓ+RuO₂ composite sensing electrode 14 was tested in pH buffer solution. The change of the pH of the solution was realized by an acid-base titration, the dynamic range being from 2 to 12 pH. FIG. 5 illustrates the response potential (sensitivity) as a function of pH for the Bi₂Ru₂O₇₊ₓ+RuO₂ composite sensing electrode 14. The Nerstian slope is 58 mV/pH for the Bi₂Ru₂O₇₊ₓ+RuO₂ composite sensing electrode 14 at 23° C. Statistical analysis of the results for the slope and E indicate that the standard deviation of emf E was ±1.0 mV. The response time to pH changes was within few seconds at a temperature of 23° C. and the response time to pH changes was within few minutes at a temperature of 9° C.

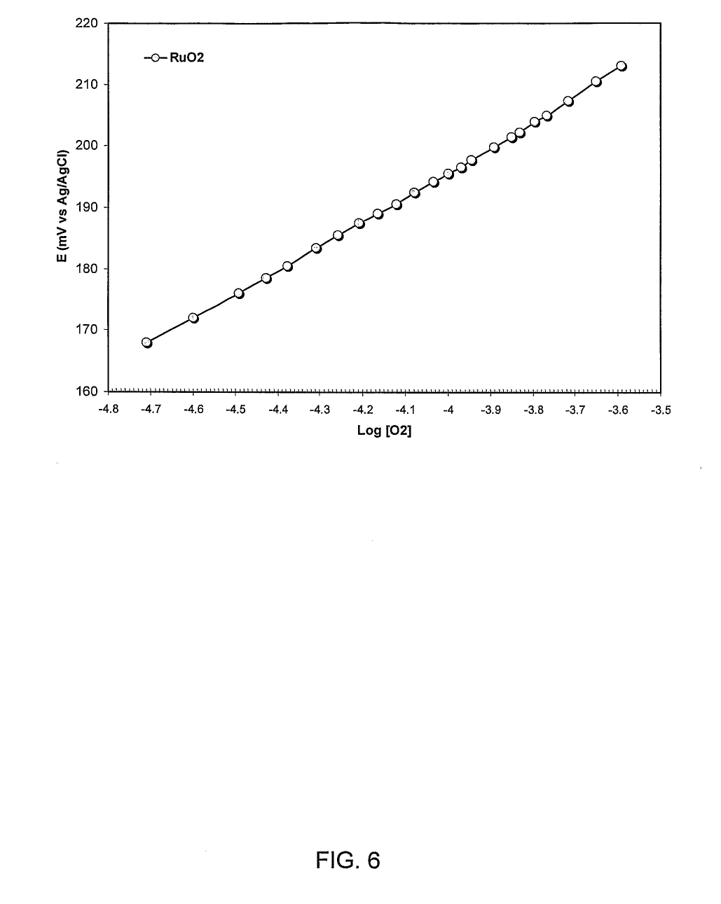

The performance of the dissolved oxygen Bi₂Ru₂O₇₊ₓ+RuO₂ composite sensing electrode 18 and the Ag/AgCl reference electrode 20, were tested potentiometrically in the temperature range of 9 to 23° C. The results are illustrated in the graph of FIG. 6. The Bi₂Ru₂O₇₊ₓ+RuO₂ composite sensing electrode 18 shows a linear response as a function of the logarithm of the dissolved oxygen concentration in the 0.6 to 8.0 ppm range. The composite sensing electrode 18 displays a Nernstian slope of 59 mV/decade at 23° C. The value of this slope suggests the presence of a reaction involving one electrode per oxygen molecule that was tentatively attributed to the formation of super-oxide ions (O²⁻) at the Bi₂Ru₂O₇₊ₓ+RuO₂ composite sensing electrode 18. This data has been confirmed by the independent FTIR measurements on the Bi₂Ru₂O₇₊ₓ+RuO₂ composite sensing electrode 18 with strong band at 722 cm⁻¹ representing adsorption of superoxide oxygen ions O²⁻.

As described above, for the conductivity measurement, an alternative square wave voltage was applied that produces a fall of voltage between the two Bi₂Ru₂O₇₊ₓ+RuO₂ composite sensing electrodes 16 and 17 which is proportional to the conductivity of the water. To achieve that, the applied signal is absent of a constant voltage, in order to avoid electrolysis of the liquid, and a positive voltage between V1 and V2 is applied and vice versa with the aim of obtaining a periodical signal with a zero charge mean value. A short response time of less than two minutes and no significant hysteresis effects were obtained for the integrated water quality monitoring sensor using Bi₂Ru₂O₇₊ₓ+RuO₂ composite sensing electrodes 16 and 17.

The in-situ device in accordance with the present invention is capable of simultaneously detecting and measuring pH, dissolved oxygen, temperature, conductivity and turbidity. Each measurement is an independent measurement.

In accordance with at least one embodiment of the invention, improved sensor sensitivity is achieved by a combination of increasing the mol. % of Ruthenium oxide together with specific selection of a second phase to improve adhesion of the sensing electrode to the ceramic substrate. In accordance with at least another embodiment of the invention a compact device having improved sensor sensitivity is achieved. The configuration of the device, with particular reference to the turbidity sensor relative to the substrate is such that a continuous flow of water impinges on the components of the turbidity sensor irrespective of the orientation of the device when immersed in a body of water.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive. For instance, it should be appreciated that the components of the device may be incorporated in a small, portable and stand-alone integrated system for in-situ water quality monitoring, which can be a part of integrated sensor networks. The in-situ device may be adapted to be positioned in a pipeline to measure, or evaluate, properties of a body of water (or indeed, properties of another fluid). The body of water may be static body of water or the body of water may be a flow.
1. Ramón Martínez-Mánez, et. al., A multisensory in thick-film technology for water quality control, Sensors and Actuators A., Elsevier, 11 Apr. 2005.

1. A composite material for use in a sensing electrode said composite material comprising a first phase and a second phase wherein said first phase consists essentially of Bi2Ru2O7+x, where x is a value between 0 and 1, and wherein said second phase consists essentially of RuO2.

2. A sensing electrode comprising a composite material according to claim 1 applied to a substrate.

3. The sensing electrode according to claim 2, wherein the substrate is alumina.

4. The sensing electrode according to claim 3, wherein the alumina substrate is coated with a thin Pt film.

5. The sensing electrode according to claim 4, where the Pt film has a thickness of between 3 μm and 15 μm.

6. The sensing electrode according to claim 5, where the Pt film has a thickness of between 5 μm and 10 μm.

7. A method of preparing a composite material according to claim 1, comprising the steps of:
(a) mixing RuO2, Bi2O3 and SiO2 in the molar ratio 68:22:10 (RuO2:Bi2O3:SiO2) to form a mixture;
(b) heating said mixture in air from ambient temperature to about 400° C. at a rate of 65° C. per hour and retaining the mixture at about 400° C. for two hours;
(c) subsequently heating said mixture to about 965° C. at a rate of 100° C. per hour whereby the first and second phases are formed.

8. The method according to claim 7, where the mixture of step (a) is applied to a substrate before the mixture is heated in step (b).

9. The method according to claim 8, where the RuO2, Bi2O3 and SiO2 are in the form of powders.

10. The method according to claim 9, where the respective powders are nanopowders which have an average particle size of between 10 nm and 500 nm.

11. The method according to claim 10, where the RuO2 nanopowder is heated in air at 900° C. for 2 hours prior to step (a).

12. An in-situ device for evaluating the quality of a body of water, the in-situ device comprising:
a planar substrate which is immersible in a body of water;
a plurality of sensing electrodes supported on a surface of the planar substrate, each sensing electrode responsive to a different parameter to measure the quality of the body of water; and
a signal processing unit to process signals received from each of the sensing electrodes to provide a measure of the quality of the body of water, where each sensing electrode is electrically connected to the signal processing means via a conductor supported on the surface of the substrate;
where at least one sensing electrode comprises a composite material according to claim 1.

13. The in-situ device according to claim 12, wherein a portion of the planar substrate comprises an aperture for the passage of water there-through.

14. The in-situ device according to claim 13, wherein the sensing electrodes include:
a pair of conductivity sensing electrodes for measuring conductivity;
a pH sensing electrode for measuring pH; and
a dissolved oxygen sensing electrode for measuring dissolved oxygen.

15. The in-situ device according to claim 12, further comprising a turbidity sensor which includes a light emitter and a first photodetector, wherein the light emitter is supported on a surface of the planar substrate and configured to emit light across the aperture and the photodetector is supported on a surface of the planar substrate and configured to receive emitted light and produce a signal indicative of the received light.

16. (canceled)

17. The in-situ device according to claim 15, wherein the turbidity sensor includes a second photodetector, and the configuration of the first and second photodetectors relative to the light emitter is such that the first photodetector provides a measure of the absorption of light by non-dissolved particles in the water and the second photodetector provides a measure of the dispersion of light by non-dissolved particles in the water.

18. The in-situ device according to claim 14, further comprising a reference electrode, wherein the signal processing unit is in communication with a potential difference measuring device which is operable to measure a potential difference between the pH sensing electrode and the reference electrode and between the dissolved oxygen sensing electrode and the reference electrode.

19. The in-situ device according to claim 18, further comprising a temperature sensor, where the signal processing unit calculates the pH from values of the potential difference and from values representative of the temperature which are delivered respectively by the pH sensing electrode, the reference electrode and the temperature sensor.

20. (canceled)

21. The in-situ device according to claim 12, wherein the signal processing unit is in communication with a conductivity meter which is operable to measure a potential between the pair of conductivity sensing electrodes.

22. An in-situ device for evaluating the quality of a body of water, the in-situ device comprising:
a planar substrate which is immersible in a body of water, the planar substrate comprising an aperture for the passage of water there-through;
a turbidity sensor including a light emitter and a first photodetector, where the light emitter is supported on a surface of the planar substrate and configured to emit light across the aperture, and where the photodetector is supported on a surface of the planar substrate and configured to receive emitted light and produce a signal indicative of the received light;
a plurality of sensing electrodes supported on a surface of the planar substrate, each sensing electrode responsive to a different parameter to measure the quality of the body of water; and
a signal processing unit to process signals received from the turbidity sensor and each of the plurality of sensing electrodes to provide a measure of the quality of the body of water, where the turbidity sensor and each sensing electrode is electrically connected to the signal processing means via a conductor supported on the substrate.

23. The in-situ device according to claim 22, wherein at least one sensing electrode is the sensing electrode as claimed in claim 2.

24. (canceled)

25. The in-situ device according to claim 22, wherein the turbidity sensor includes a second photodetector, and the configuration of the first and second photodetectors relative to the light emitter is such that the first photodetector provides a measure of the absorption of light by non-dissolved particles in the water and the second photodetector provides a measure of the dispersion of light by non-dissolved particles in the water.

26. The in-situ device according to claim 22, wherein the sensing electrodes include:
a pair of conductivity sensing electrodes for measuring conductivity;
a pH sensing electrode for measuring pH; and
a dissolved oxygen sensing electrode for measuring dissolved oxygen.

27. (canceled)
